(19) United States
(12) Patent Application Publication
(10) Pub. No.: US 2012/0315856 A1
(43) Pub. Date: Dec. 13, 2012

(54) TERMINAL AND METHOD FOR COMMUNICATING IN RESPONSE TO CONTACT

(75) Inventors: Jung-Suk KO, Seoul (KR); Song LIM, Seoul (KR)

(73) Assignee: PANTECH CO., LTD., Seoul (KR)

(21) Appl. No.: 13/324,018

(22) Filed: Dec. 13, 2011

(30) Foreign Application Priority Data
Dec. 14, 2010 (KR) 10-2010-0127685

(51) Int. Cl. H04B 17/00

(52) U.S. Cl. 455/67.11

(57) ABSTRACT

A terminal to convert data based on contact includes a receiver condition storage to store condition information for selecting or converting original stored data to be transmitted to a terminal of a second user, a contact sensor to sense contact between the first user and the second user; and a controller to modify the stored data to be transmitted from the terminal of the first user to a terminal of the second user based on the condition information if contact exists between the first user and the second user. A method for communicating data between a first terminal of a first user and a second terminal of a second user, includes: detecting contact between the first user and the second user; generating a signal corresponding to the contact; converting the signal to a digital signal; and transmitting stored data according to the digital signal.

### CROSS-REFERENCE TO RELATED APPLICATION

This application claims priority from and the benefit under 35 U.S.C. §119(a) of Korean Patent Application No. 10-2010-0127685, filed on Dec. 14, 2010, which is incorporated by reference for all purposes as if fully set forth herein.

### BACKGROUND

1. Field

Exemplary embodiments of the present invention relate to a terminal and method for communicating in response to contact, and more particularly, interpreting and converting data according to a receiver's characteristics and providing the converted data to the receiver.

2. Discussion of the Background

A technology has been developed for exchanging data (still images, moving images, music, text, etc.) stored in a sensor or terminal attached or carried by a person, that has a transmitter and a receiver, using the person as a communication medium. This technology uses micro-current flowing through a body as a medium for communication, the communication being done without a power supply. Accordingly, this communication technology can transmit/receive data if at least two people make contact (touching fingers, shaking hands or the like), and thus, the communication is not via a network, such as the Internet. This technology provides an intuitive service by allowing contact between people to facilitate communication between mobile devices.

Facets of this technology include techniques for sensing a contact between parties, analyzing signals for processing data, electrodes, and hardware components. A technique for sensing contact, which is used to sense or determine whether a person contacts a transmitting or receiving device, has been developed by various entities, such as Matsushita Electric Industrial Co. Ltd. and NTT (an ElectAura-Net operation). The technique developed by Matsushita electric Industrial Co. Ltd. works by contacting the electrodes of a transceiver to a person, with the changes in micro-current flowing through the person represented as “0” and “1”. The current flowing through the person has little influence on the person since the current is relatively small (about 500 μA).

The technique by NTT (ElectAura-Net operation), utilizes changes in a surface electric field of a person. Specifically, it uses a transmitter, with a data rate above 100 Mbps, power of 2.7 W, and an Electro optic probe operation to apply a voltage to a person with an insulator, to change the surface electric field of the person, and to amplify the small change using a photonic electric sensor installed in a receiver. A receiver allows the signal to be read.

However, the conventional technology does not convert or interpret data while transmitting data from one person to another person using this type of communication. That is, the conventional technology transmits the same data to a plurality of receivers without considering a characteristic associated with a specific receiver. Thus, if a receiver (based on a characteristic associated with the device of the receiver or the person associated with the receiver) may utilize the received data in a specific way, the conventional technology does not allow the receiver to utilize or receive data in a specific way.

The above information disclosed in this Background section is only for enhancement of understanding of the background of the invention and therefore it may contain information that does not form any part of the prior art.

### SUMMARY OF THE INVENTION

Exemplary embodiments of the present invention provide a terminal, and a method for communication in response to contact, and specifically, the contact referring to two people touching each other, with the touching communicating either micro-current or other techniques for sensing contact between parties.

Additional features of the invention will be set forth in the description which follows, and in part will be apparent from the description, or may be learned by practice of the invention.

An exemplary embodiment of the present invention discloses a terminal, includes: a contact sensor to detect contact between the first user and a second user, and to generate a signal corresponding to the contact; a controller to convert the signal from the contact sensor to a digital signal; a receiver condition storage to store condition information associated with the is digital signal; and an original data storage to store data.

An exemplary embodiment of the present invention discloses a method for communicating data between a first terminal of a first user and a second terminal of a second user, includes: detecting contact between the first user and the second user; generating a signal corresponding to the contact; converting the signal to a digital signal; and transmitting stored data according to the digital signal.

An exemplary embodiment of the present invention discloses a receiving terminal, includes: a contact sensor to sensor to detect contact between a first user of the receiving terminal and a second user; and a communication unit to receive data from a transmitting terminal of the second user, wherein the data is modified by the transmitting terminal based on an attribute associated with the first user, and then transmitted by the transmitting terminal to the receiving terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a diagram illustrating a terminal according to an exemplary embodiment of the present invention.

FIG. 2 is a flowchart illustrating a method for communicating data in response to contact according to an exemplary embodiment of the present invention.

FIG. 3 is a view illustrating the encryption and transfer of data according to an exemplary embodiment of the present invention.

FIG. 4 is a view illustrating the translation and transfer of data according to an exemplary embodiment.

FIG. 5 is a view illustrating the transfer of phone number data according to an exemplary embodiment.

FIG. 6 is a view illustrating the conversion of data based on biometric states according to an exemplary embodiment.

FIG. 7 is a view illustrating the conversion of data based on gender or age according to an exemplary embodiment.

Throughout the drawings and the detailed description, unless otherwise described, the same drawing reference numerals will be understood to refer to the same elements, features, and structures. The relative size and depiction of these elements may be exaggerated for clarity, illustration, and convenience.

### DETAILED DESCRIPTION OF THE ILLUSTRATED EMBODIMENTS

Exemplary embodiments now will be described more fully hereinafter with reference to the accompanying drawings, in which exemplary embodiments are shown. The present disclosure may, however, be embodied in many different forms and should not be construed as limited to the exemplary embodiments set forth therein. Rather, these exemplary embodiments are provided so that the present disclosure will be thorough and complete, and will fully convey the scope of the present disclosure to those skilled in the art. In the description, details of well-known features and techniques may be omitted to avoid unnecessarily obscuring the presented embodiments.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. Furthermore, the use of the terms a, an, etc. does not denote a limitation of quantity, but rather denotes the presence of at least one of the referenced item. The use of the terms “first”, “second”, and the like does not imply any particular order, but they are included to identify individual elements. Moreover, the use of the terms first, second, etc. does not denote any order or importance, but rather the terms first, second, etc. are used to distinguish one element from another. It will be further understood that the terms “comprises” and/or “comprising”, or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Unless otherwise defined, all terms (including technical and scientific terms) used herein have the same meaning as commonly understood by one of ordinary skill in the art. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

It will be understood that for the purposes of this disclosure, “at least one of X, Y, is and Z” can be construed as X only, Y only, Z only, or any combination of two or more items X, Y, and Z (e.g., XYZ, XYY, YZ, ZZ).

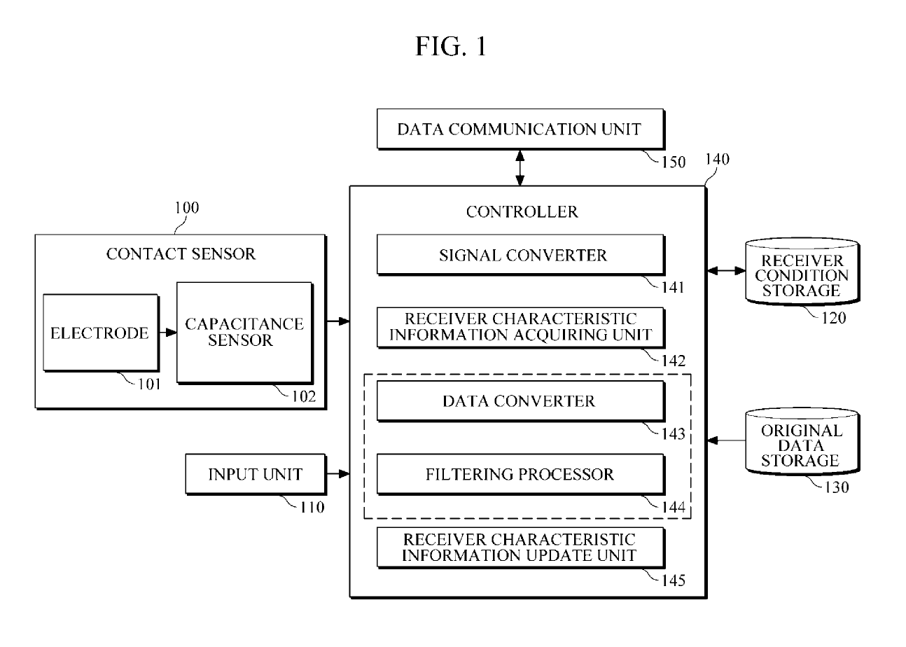

FIG. 1 is a diagram illustrating a terminal according to an exemplary embodiment of the present invention.

As illustrated in FIG. 1, the terminal to communicate via a body of a person includes a contact sensor 100, an input unit 110, a receiver condition storage 120, an original data storage 130, and a controller 140. The contact sensor 100 senses contact between a transmitter and a receiver, and generates an electrical signal in response to the sensed contact. Contact between a transmitter and a receiver may refer to a person with a terminal device (i.e. a transmitter) making contact with another person with a terminal device (i.e. a receiver). For example, if the two people shake hands, contact may be initiated by detection via the contact sensor 100. The communication after contact is made may occur through micro-current associated with person to person contact. The contact sensor 100 includes at least one electrode 101 to receive and transmit signals in response to contact, and at least one capacitance sensor 102 to detect capacitance based on contact or a proximity to a person. The capacitance sensor 102 may be disposed along with the electrode 101. That is, if contact occurs, the electrode 101 outputs a signal indicating this contact, and the capacitance sensor 102 detects capacitance from the signal output from the electrode 101 and outputs an electrical signal corresponding to the detected capacitance.

The controller 140 receives the signal (which may be electrical) from the capacitance sensor 102 and converts the signal into a digital signal through a signal converter 141. The controller 140 acquires characteristic information, which pertains to information of a receiver associated with the digital signal, from the receiver condition storage 120, and uses the is receiver characteristic information to modify the original data to be provided to the receiver, and transmits the modified data to the receiver's terminal. The receiver condition storage 120 stores receiver characteristic information, which may include condition information (of the receiver) and signal pattern information, wherein the condition information is used to modify the original data. The original data may refer to any sort of data to be delivered to a receiver terminal, for example, still images, moving images, music, text, and the like, and may be stored in the original data storage 130. The signal pattern information may be a specific signal pattern, and may be correlated with the detected signal to determine the receiver or other information if contact is made.

The condition information may be set via the transmitter through the input unit 110. For example, the transmitter may input condition information based on a degree of intimacy between the user of the transmitter and the users of various receivers. This condition information may reflect each of the receivers' tastes, and an importance or priority of data associated with the condition information that may be input through the input unit 110. After the condition information is received, the controller 140 obtains receiver characteristic information based on the condition information and signal pattern information about the receiver that the condition information is correlated to. The receiver characteristic information may be obtained through the receiver characteristic information acquiring unit 142, and may be stored in the receiver condition storage 120.

Thereafter, the controller 140 controls the receiver characteristic information acquiring unit 142 and a data converter 143 to convert original data related to the received data information, and transmits the converted data to the receiver's terminal after contact is made.

The receiver characteristic information acquiring unit 142 acquires from the is digital signal converted by the signal converter 141, receiver characteristic information associated with receiver characteristic information stored in the receiver condition storage 120. As described above, the receiver characteristic information includes condition information for converting original data according to a specific receiver's preference, and signal pattern information about the receiver. Thus, the receiver characteristic information acquiring unit 142 acquires receiver characteristic information from the receiver condition storage 120. The receiver character information may include reference signal pattern information corresponding to the digital signal, and may correspond to one of a plurality of reference signal patterns stored in the receiver condition storage 120. After the receiver characteristic information is acquired, a data converter 143 retrieves for original data relating to the data information received from the input unit 110 from the original data storage 130, and converts the original data based on the receiver characteristic information. Specifically, the data converter 143 converts the original data according to the receiver characteristic information in various ways, such as, correcting, adding or deleting the original data according to the receiver characteristic information. After the conversion, the converted original data is transmitted to the receiver's terminal after contact is made. This transmission may be facilitated through the data communication unit 150.

The controller 140 includes a filtering processor 144 to filter the original data based on the receiver characteristic information. For example, the filtering processor 144 extracts the data that is to be transmitted to a corresponding receiver from the original data, and transmits the extracted data to the receiver's terminal after contact is made. For example, if a user of the transmitting terminal denotes that picture files are provided to a specific receiver's terminal after contact is made, the filtering processor 144 may extract picture files associated with the receiver from among the picture files stored in the original data storage 130, and is transmit the extracted picture files to the receiver's terminal after contact is made. In another example, if a data transfer request related to a receiver is received, the filtering processor 144 may extract data associated with the receiver from original data stored in the original data storage 130, and transmit the extracted data to the receiver's terminal after contact is made.

In another example, the receiver condition storage 120 stores reference information conditions for providing reference information about original data. Accordingly, if no receiver characteristic information associated with a digital signal from the signal converter 141 is acquired by the receiver characteristic information acquiring unit 143, the data converter 143 converts the original data according to the reference information conditions stored in the receiver condition storage 120. The data converter 144 transmits the converted data to the receiver's terminal after contact is made. In another example, the controller 140 may control the receiver characteristic information update unit 145 to create new receiver characteristic information associated with the digital signal if no receiver characteristic information has been previously acquired, and store the new receiver characteristic information in the receiver condition storage 120. That is, alternatively to using receiver characteristic information associated with a certain digital signal, the receiver characteristic information update unit 146 may determine that no receiver characteristic information is associated with the digital signal, create receiver characteristic information associated with the digital signal, and store the new receiver characteristic information in the receiver condition storage 120. Also, the receiver characteristic information update unit 145 updates, if receiving an update request from the input unit 110, the corresponding receiver characteristic information, and stores the updated receiver characteristic information in the receiver condition storage 120.

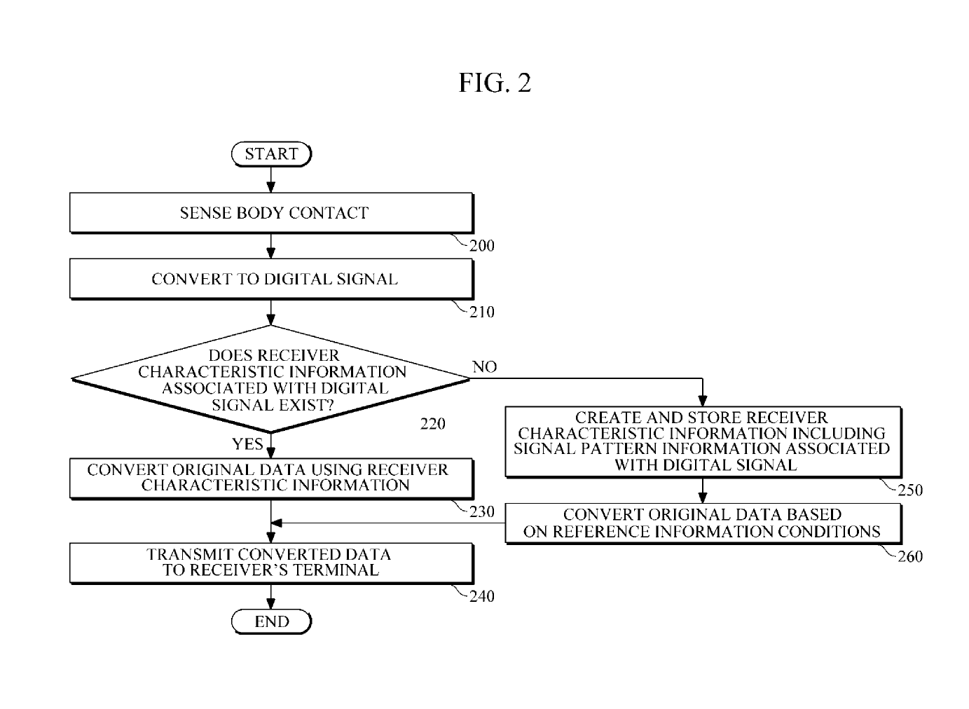

FIG. 2 is a flowchart illustrating a method for communicating data in response to is contact according to an exemplary embodiment of the present invention

Referring to FIG. 2, the transmitter's terminal senses contact between a user of the transmitter and a user of a receiver (200). The transmitter's terminal converts an electrical signal generated by the body contact to a digital signal (210). That is, the transmitter's terminal senses a body contact, detects capacitance from a signal according to the body contact, and outputs the capacitance as an electrical signal. The transmitter's terminal may convert the electrical signal to a digital signal. Thereafter, the transmitter's terminal determines whether receiver characteristic information exists that is associated with the digital signal, and whether the receiver characteristic information is stored in the transmitter's terminal (220). The stored receiver characteristic information includes condition information for converting original data based on the receiver's characteristics, and signal pattern information about various receivers. Specifically, the condition information may be used to convert a variety of formats and types of original data (for example, still images, moving images, music, text, etc.) based on a preference (or receivers' characteristics) of the user of the receiver's terminal. The signal pattern information is used to provide specific signal patterns after contact is made. The condition information, which may have been previously set by a user of the transmitter's terminal, is used to convert original data based on the specific receiver to be delivered the original data. The condition information may be chosen and set based on relationships between either the devices or users of the transmitting and receiving terminals, data importance, or the receivers' preferences. The receiver characteristic information is stored in the receiver condition storage, and accordingly, the transmitter's terminal may determine whether signal pattern information associated with the corresponding digital signal exists by comparing the digital signal with the signal pattern information of the receiver characteristic information stored in the receiver is condition storage.

If receiver characteristic information associated with the digital signal exists, the transmitter's terminal converts the original data, and transmits the converted data to the receiver's terminal (230 and 240). The user of the transmitter may set condition information so that the receiver has access to all or a part of the original data, according to a relationship with the receiver. If the condition information included in the receiver characteristic information indicates that only a part of original data is to be provided to the receiver, the transmitter's terminal converts the original data so that a part of the original data is provided to the receiver, and transmits the converted data to the receiver's terminal, so that the receiver has access to the part of the original data via the receiver's terminal.

The transmitter may set condition information so that selected data associated with the receiver to receive the original data is extracted and provided to the receiver. For example, if picture files are to be provided to a receiver, a transmitter's terminal may extract the picture files associated with the receiver, and transmits the extracted picture files to the receiver's terminal. Accordingly, the receiver's terminal receives the picture files containing himself or herself stored in the transmitter's terminal, and may store them.

If the transmitter's terminal determines that no receiver characteristic information is associated with the digital signal, the transmitter's terminal may create receiver characteristic information (including signal pattern information associated with the corresponding digital signal), and store the new receiver characteristic information in the receiver condition storage (250). After which, the transmitter's terminal converts the original data according to either the pre-existing or created reference information condition, and transmits the converted data to the receiver's terminal (260).

As such, the transmitter may convert original data according to various users and terminals associated with a receiver based on receiver characteristic information and transmit the converted data to the corresponding receivers.

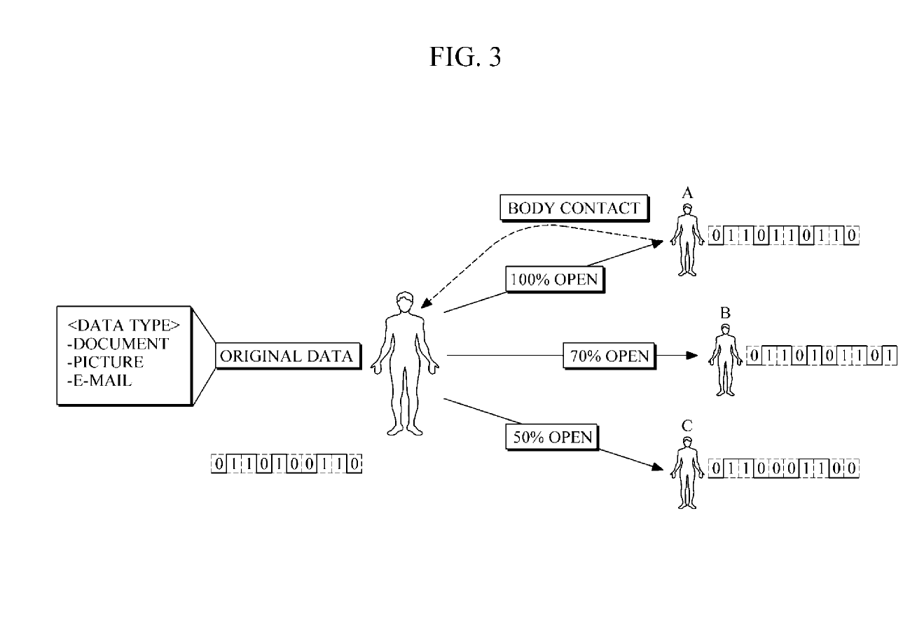

FIG. 3 is a view illustrating the encryption and transfer of data according to an exemplary embodiment of the present invention.

As illustrated in FIG. 3, a transmitter sets condition information specifically for different receiver terminals. The condition information may be used to set various permissions and amount of data that may be shared or transmitted between the transmitter terminal and the receiver terminal. The data that the condition information may be associated with may include, but not be limited to, text, pictures, E-mail information and the like. For example, and as shown, the transmitter may set condition information such that a receiver “A” has access to all of the original data, a receiver “B” has access to 70% of the original data, and a receiver “C” has access to 50% of the original data. As such, after the access condition information for each receiver is set, the transmitter's terminal stores receiver characteristic information including signal patterns about receivers “A”, “B”, and “C” and the condition information set by the transmitter, in the receiver condition storage. Thereafter, if contact is made between the transmitter and the receivers “A”, “B” and “C”, the transmitter's terminal converts electrical signals generated based on the contact into digital signals, and acquires receiver characteristic information about the receivers “A”, “B”, and “C” stored in the receiver condition storage through the digital signals. Then, the transmitter's terminal encrypts or converts the original data based on the receiver characteristic information about the receivers “A”, “B”, and “C” so that receiver “A” has access to all the original data, the receiver “B” has access to 70% of the original data, and the receiver “C” can gain 50% of the original data. According to an example, the transmitter's terminal is encrypts the original data to binary numbers and transmits the encrypted data to terminals of the individual receivers “A”, “B”, and “C”. Accordingly, the terminals of the receivers “A”, “B”, and “C” respectively decrypt the encrypted data so that the receivers “A”, “B”, and “C” can read 100%, 70%, and 50% of the decrypted data, respectively.

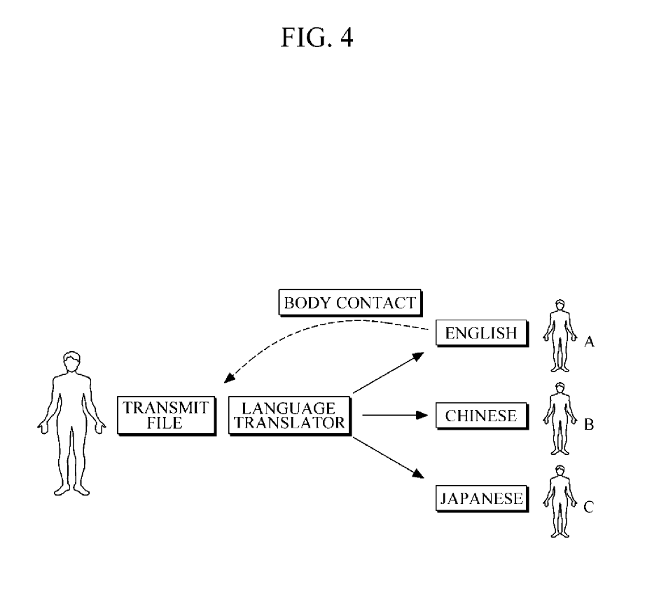

FIG. 4 is a view illustrating the translation and transfer of data according to an exemplary embodiment.

As illustrated in FIG. 4, a user of a transmitter terminal sets condition information in his or her terminal to translate original data, to a language associated with a user of a receiver terminal based on contact being made between the users. The user of the transmitter terminal may set condition information so that an English translation of stored document is provided to the receiver “A”, a Chinese translation of the stored document is provided to the receiver “B”, and a Japanese translation of the stored document is provided to the receiver “C”. As such, after the translation condition information for each receiver is set, the transmitter's terminal stores the receiver characteristic information, including signal patterns about the receivers “A”, “B”, and “C”, and the translation condition information in the receiver condition storage.

Thereafter, if contact is made with any of the receivers “A”, “B”, and “C”, the transmitter's terminal converts electrical signals generated during the contact to digital signals, and based on a match of the digital signal with a stored signal associated with a specific receiver, acquires the receiver characteristic information about one, some or all of the matched receivers in the receive condition storage. Then, the transmitter's terminal transmits an English translation of the corresponding original document to the terminal of the receiver “A”, a Chinese translation of the original document to the terminal of the receiver “B”, and a Japanese translation of the original document to the terminal of the receiver “C”, according to the translation condition is information of the receiver characteristic information about receivers “A”, “B”, and “C”.

Accordingly, the terminals of the receivers “A”, “B”, and “C” receive English, Chinese, and Japanese translations of the original document, respectively, so that users of the receivers “A”, “B”, and “C” may read the original documents in their native or preferred language.

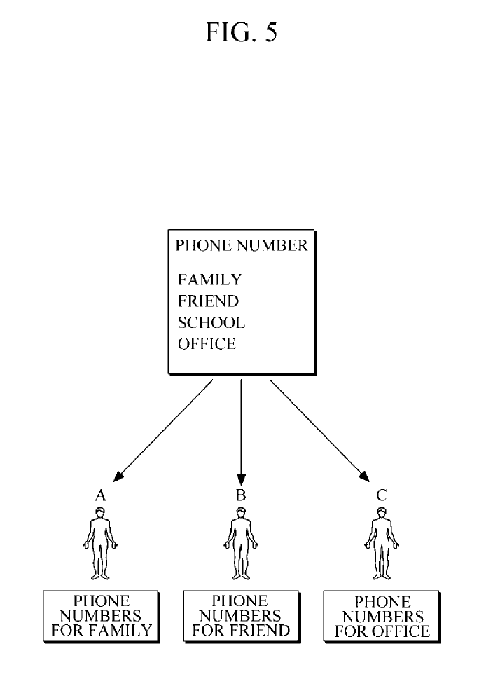

FIG. 5 is a view illustrating the transfer of phone number data according to an exemplary embodiment.

As illustrated in FIG. 5, a user of a transmitter terminal sets condition information to provide specific receivers with phone numbers, the phone numbers being stored according to groups, such as school, friend, family, office, and the like. The transmitter's terminal stores receiver characteristic information including signal patterns about various receivers, such as receivers “A”, “B”, and “C”, and condition information relating to sharing the phone numbers, in the receiver condition storage. Thereafter, if contact occurs between the transmitter and any one of the receivers “A”, “B” and “C”, the transmitter's terminal detects a digital signal generated by the contact, and acquires receiver characteristic information about the receiver (either receiver “A”, “B”, or “C”) that corresponds to the digital signal, from the receiver condition storage. After the corresponding receiver characteristic information is acquired, the transmitter's terminal transmits phone number information according to the set condition information. For example, as shown, the transmitter terminal transmits a family group to the terminal of the receiver “A”, a friend group to the terminal of the receiver “B”, and an office group to the terminal of the receiver “C”. Accordingly, the transmitter may provide the receivers “A”, “B”, and “C” with phone numbers associated with the receivers “A”, “B”, and “C” among a plurality of phone numbers stored in the terminal in response to contact being made.

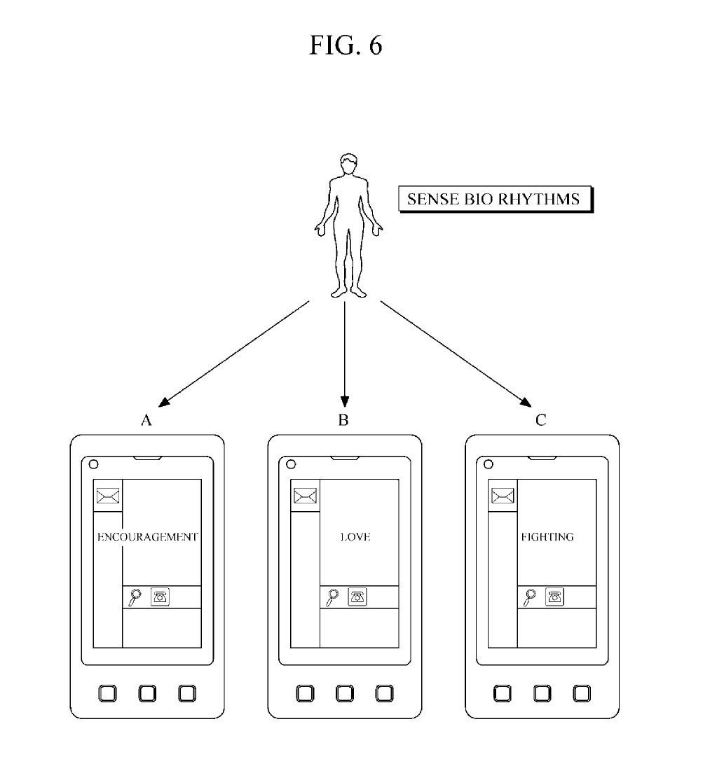

FIG. 6 is a view illustrating the conversion of data based on biometric states according to an exemplary embodiment.

As illustrated in FIG. 6, the user of the transmitter terminal sets condition information according to various biometric states associated with receivers. The terminal stores receiver characteristic information including signal patterns about the receivers “A”, “B”, and “C” and the set conditional information associated with each receiver in the receiver condition storage. If contact between the user of the transmitter and any one of the users of the receivers “A”, “B”, or “C” occurs, the transmitter's terminal detects a digital signal generated by the contact, and acquires receiver characteristic information about the receiver (either receiver “A”, “B”, or “C”) that corresponds to the digital signal, from the receiver condition storage. Also, the terminal senses bio rhythms based on the contact between the transmitter and one of the receivers. Thereafter, the terminal compares the bio rhythms with the condition information according to the biometric states included in the receiver characteristic information of the receivers “A”, “B”, and “C”, to transmit music files, messages, etc. related to or appropriate based on the bio rhythm sensed or the biometric state set between the transmitter and the receiver. For example, as shown, the transmitter may transmit data associated with “encouragement” to the terminal of the receiver “A”, data associated with “love” to the terminal of the receiver “B”, and data associated with “arguing” to the terminal of the receiver “C”. A sensed bio rhythm, or bio metric states, may pertain to detecting some metric associated with a physical condition (such as heart rate, body temperature, or the like), and the sensed bio rhythm may be correlated with one of the above enumerated moods used to select appropriate data from transmitting from one device to another.

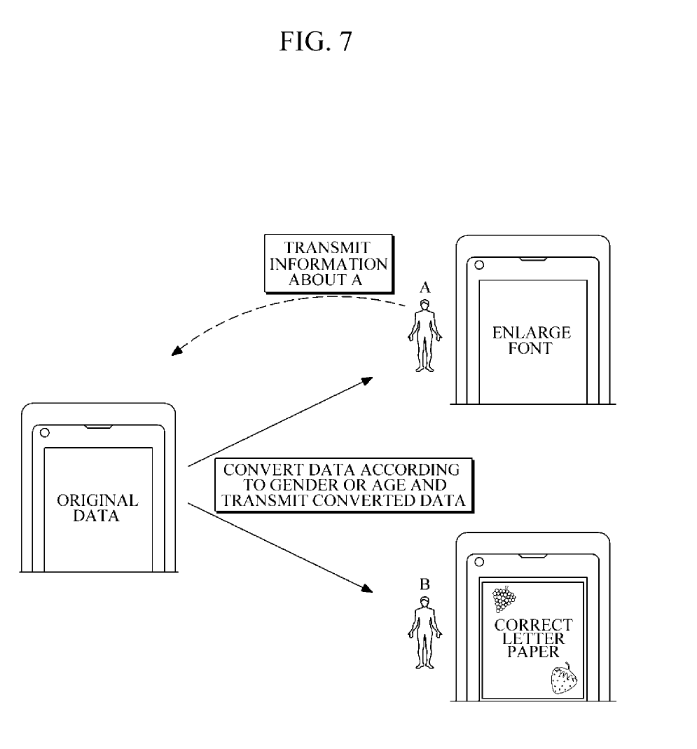

FIG. 7 is a view illustrating the conversion of data based on gender or age is according to an exemplary embodiment.

As illustrated in FIG. 7, a user of the transmitter terminal sets condition information associated with the users' gender or age. The terminal stores receiver characteristic information including signal patterns about receivers “A” and “B” and the condition information in the receiver condition storage. If contact occurs between the transmitter and one of the receivers, the transmitter's terminal associates a digital signal based on the contact to ascertain the receiver corresponding to the digital signal. The transmitter's terminal transmits text information, for example, text information having an enlarged font size or a music file suitable for the age of the receiver “A” to the terminal of the receiver “A”, or transmits a background screen of text information converted according to the gender of the receiver “B” or a music file suitable for the age of the receiver “B” to the terminal of the receiver “B”, based on the condition information included in the receiver characteristic information about the receivers “A” and “B”. Thus, in this example an attribute of the receiver is preset, such as age or gender, and the data transmitted from the transmitter to the receiver accounts for this attribute.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A terminal, comprising:
a contact sensor to detect contact between the first user and a second user, and to generate a signal corresponding to the contact;
a controller to convert the signal from the contact sensor to a digital signal;
a receiver condition storage to store condition information associated with the digital signal; and
an original data storage to store data.

2. The terminal according to claim 1, further comprising:
a communication unit to transmit the data,
wherein the receiver condition storage stores signal pattern information that corresponds to the signal corresponding to the contact between the first user and the second user.

3. The terminal according to claim 2, wherein the controller determines that contact exists between the first user and the second user if the digital signal matches the signal pattern information.

4. The terminal according to claim 3, wherein the communication unit transmits a portion of the data according to the condition information associated with the digital signal if contact is determined to exist between the first user and the second user.

5. The terminal according to claim 4, wherein the controller converts the portion of the data based on an attribute.

6. The terminal according to claim 5, wherein the attribute is language translation between the first user and the second user.

7. The terminal according to claim 5, wherein the attribute is a level of sharing between the first user and the second user.

8. The terminal according to claim 5, wherein the attribute is based on a sensed biorhythm of the contact between the first user and the second user.

9. The terminal according to claim 2, wherein the contact sensor detects the contact based on a change of micro-current flowing through the first user.

10. A method for communicating data between a first terminal of a first user and a second terminal of a second user, comprising:
detecting contact between the first user and the second user;
generating a signal corresponding to the contact;
converting the signal to a digital signal; and
transmitting stored data according to the digital signal.

11. The method according to claim 10, further comprising:
identifying signal pattern information that corresponds to the signal corresponding to the contact between the first user and the second user.

12. The method according to claim 11, further comprising determining that contact exists between the first user and the second user if the digital signal matches the signal pattern information.

13. The method according to claim 12, wherein transmitting stored data comprises transmitting a portion of data stored in a data storage according to condition information associated with the digital signal.

14. The method according to claim 13, further comprising converting the portion of the data based is based on an attribute.

15. The method according to claim 14, wherein the attribute is language translation between the first user and the second user.

16. The method according to claim 15, wherein the attribute is a level of sharing between the first user and the second user.

17. The method according to claim 16, wherein the attribute is based on a sensed biorhythm of the contact between the first user and the second user.

18. The method according to claim 11, wherein the detection of contact is based on a change of micro-current flowing through the first user.

19. A receiving terminal, comprising:
a contact sensor to sensor to detect contact between a first user of the receiving terminal and a second user; and
a communication unit to receive data from a transmitting terminal of the second user,
wherein the data is modified by the transmitting terminal based on an attribute associated with the first user, and then transmitted by the transmitting terminal to the receiving terminal.

20. The receiving terminal according to claim 19, wherein the contact sensor senses a change of micro-current flowing through the first user.
